(19) United States
(12) Patent Application Publication
(10) Pub. No.: US 2019/0158366 A1
(43) Pub. Date: May 23, 2019

(54) COGNITIVE ANALYSIS BASED PRIORITIZATION FOR SUPPORT TICKETS

(71) Applicant: International Business Machines Corporation, Armonk, NY (US)

(72) Inventors: ChunHui Y. Higgins, Durham, NC (US); Chuan Ran, Cary, NC (US); Camillo Sassano, Durham, NC (US); Nancy A. Schipon, Apex, NC (US); Bo Zhang, Cary, NC (US)

(21) Appl. No.: 15/815,955

(22) Filed: Nov. 17, 2017

(51) Int. Cl. H04L 12/24; G06Q 30/00; G10L 25/63; G06Q 10/06

(52) U.S. Cl. CPC H04L 41/5074; H04L 41/5022; G06Q 10/06313; G10L 25/63; H04L 41/5064; G06Q 30/016

(57) ABSTRACT

A prioritization system and method may include receiving a customer support ticket from a user, wherein a default severity level associated with the customer support ticket is assigned, calculating, by the processor, a user sentiment score and a user personality score by applying a sentiment analysis and a personality analysis to user-specific data, applying, by the processor, a weighting scheme to the user sentiment score and the user personality score to generate a weighted priority score associated with the customer support ticket, adjusting, by the processor, the default severity level according to the weighted priority score to determine an adjusted severity level of the customer support ticket, and prioritizing, by the processor, the customer support ticket among other customer support tickets based on the adjusted severity level of the customer support ticket.

### TECHNICAL FIELD

The present invention relates to systems and methods for support ticket prioritization, and more specifically the embodiments of a prioritization system for prioritizing a customer support ticket system based on severity level determined using cognitive analysis of user.

### BACKGROUND

Existing supporting systems typically assign severity categories or levels for a support team to prioritize the support team's actions. Incoming customer support tickets are assigned a default severity category.

### SUMMARY

An embodiment of the present invention relates to a method, and associated computer system and computer program product, for prioritizing a customer support ticket system. A processor of a computing system receives a customer support ticket from a user, wherein a default severity level associated with the customer support ticket is assigned. A user sentiment score and a user personality score is calculated by applying a sentiment analysis and a personality analysis to user-specific data. A weighting scheme is applied to the user sentiment score and the user personality score to generate a weighted priority score associated with the customer support ticket. The default severity level is adjusted according to the weighted priority score to determine an adjusted severity level of the customer support ticket. The customer support ticket is prioritized among other customer support tickets based on the adjusted severity level of the customer support ticket.

### BRIEF DESCRIPTION OF THE DRAWINGS

FIG. 1 depicts a block diagram of a prioritization system, in accordance with embodiments of the present invention.

FIG. 2 depicts a queue of a plurality of customer support tickets, in accordance with embodiments of the present invention.

FIG. 3 depicts a social network page of a user, containing shared content, in accordance with embodiments of the present invention.

FIG. 4 depicts a social network page of an entity, containing shared content, in accordance with embodiments of the present invention.

FIG. 5 depicts a table showing a weighted priority score calculated for a plurality of customer support tickets, in accordance with embodiments of the present invention.

FIG. 6 depicts a table showing an adjusted priority for the plurality of customer support tickets, in accordance with embodiments of the present invention.

FIG. 7 depicts a flow chart of a method for prioritizing a customer support ticket system, in accordance with embodiments of the present invention.

FIG. 8 depicts a detailed flow chart of a method for prioritizing a customer support ticket system, in accordance with embodiments of the present invention.

FIG. 9 depicts a block diagram of a computer system for the prioritization system of FIGS. 1-6, capable of implementing methods for prioritizing a customer support ticket system of FIGS. 7-8, in accordance with embodiments of the present invention.

FIG. 10 depicts a cloud computing environment, in accordance with embodiments of the present invention.

FIG. 11 depicts abstraction model layers, in accordance with embodiments of the present invention.

### DETAILED DESCRIPTION

Supporting systems can prioritize customer support tickets based on a severity level. The severity level of the customer support ticket may be assigned varying categories or levels of severity for a support team to prioritize the support team's actions. Incoming customer support tickets are assigned a default severity category, for example, ranging from a severity level of four (e.g. SEV 4) to a severity level of one (e.g. SEV 1). Many times, multiple customer support tickets will have a same severity level, and thus there is no way to prioritize between customer support tickets both being assigned the same severity level. For instance, if four customer support tickets in a customer support ticket queue are assigned SEV 1, it can be challenging for customer ticket support teams to decide which customer support ticket to address first.

Thus, there is a need for a prioritization system for prioritizing a customer support ticket system based on severity level determined using cognitive analysis of user. Embodiments of the present invention may perform/use sentimental analysis and personality insights of a user submitting a customer support ticket, in addition to customer support ticket data and customer relationship management (CRM) data, to adjust a default severity level assigned to the customer support ticket.

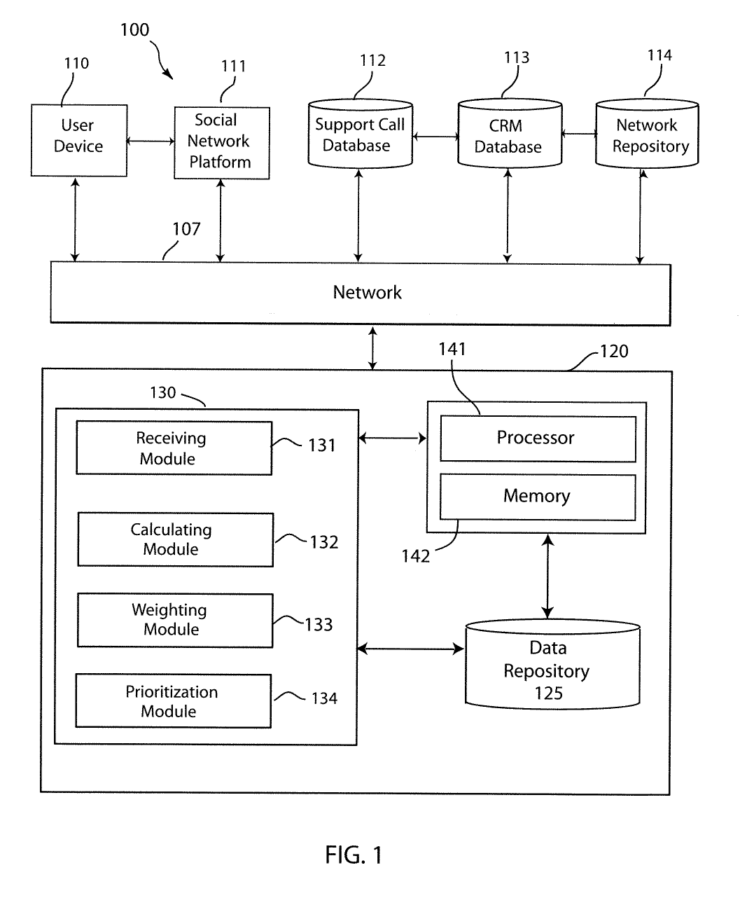

Referring to the drawings, FIG. 1 depicts a block diagram of prioritization system 100, in accordance with embodiments of the present invention. Embodiments of the prioritization system 100 may be a system for prioritizing a customer support ticket based on an adjusted severity level of the customer ticket by analyzing user-specific data. Embodiments of the prioritization system 100 may be useful for customer support teams to determine which customer support tickets should be handled first based on detailed cognitive understanding of severity levels of each individual customer support ticket. For example, customer support tickets having matching severity level do not provide enough information for a customer support team to know which customer support ticket is more severe. A severity level may refer to a category or degree of severity, urgency, importance, necessity, significance, meaningfulness, magnitude, etc. attributed to a customer support ticket, or an underlying issue, problem, need of the customer support ticket. Embodiments of a customer support ticket may be a support ticket, a customer support ticket, an issue ticket, a support request document, a request ticket, a customer issue request ticket, incident ticket, incident request ticket, a trouble ticket, or other ticket, voucher, or docket document that may help manage and track requests for support. In an exemplary embodiment, the customer support ticket may be a request for technical support for IT services, repair services, software application support, retail support, and/or general customer support.

Embodiments of the prioritization system 100 may be a customer support ticket severity determination system, a ticket prioritization system, a ticket severity adjustment system, cognitive prioritization system for determining a severity and priority of customer support tickets, and the like. Embodiments of the prioritization system 100 may include a computing system 120. Embodiments of the computing system 120 may be a computer system, a computer, a cellular phone, a mobile device, a desktop computer, a server, one or more servers, a computing device, a tablet computer, a dedicated mobile device, a laptop computer, other internet accessible/connectable device or hardware, and the like.

Furthermore, embodiments of prioritization system 100 may include a user device 110, a social network platform 111, a support call database 112, and a CRM database 113, that are communicatively coupled to a computing system 120 of the prioritization system 100 over a computer network 107. For instance, information/data may be transmitted to and/or received from the user device 110, the social network platform 111, the support call database 112, and the CRM database 113 over a network 107. A network 107 may be the cloud. Further embodiments of network 107 may refer to a group of two or more computer systems linked together. Network 107 may be any type of computer network known by individuals skilled in the art. Examples of network 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the network 107 may be a peer-to-peer network in some embodiments, wherein in other embodiments, the network 107 may be organized as a client/server architecture.

In some embodiments, the network 107 may further comprise, in addition to the computing system 120, a connection to one or more network-accessible knowledge bases 114, which are network repositories containing information of the user, social media platform account information, customer support ticket information/history, user activity, user preferences, network repositories or other systems connected to the network 107 that may be considered nodes of the network 107. In some embodiments, where the computing system 120 or network repositories allocate resources to be used by the other nodes of the computer network 107, the computing system 120 and network-accessible knowledge bases 114 may be referred to as servers.

The network-accessible knowledge bases 114 may be a data collection area on the computer network 107 which may back up and save all the data transmitted back and forth between the nodes of the computer network 107. For example, the network repository may be a data center saving and cataloging user activity data, ticket data, user data, support team data, user preference data, administrator data, and the like, to generate both historical and predictive reports regarding a particular user or customer support account, and the like. In some embodiments, a data collection center housing the network-accessible knowledge bases 114 may include an analytic module capable of analyzing each piece of data being stored by the network-accessible knowledge bases 114. Further, the computing system 120 may be integrated with or as a part of the data collection center housing the network-accessible knowledge bases 114. In some alternative embodiments, the network-accessible knowledge bases 114 may be a local repository that is connected to the computing system 120.

Embodiments of the user device 110 may be a user device, a cell phone, a smartphone, a user mobile device, a mobile computer, a tablet computer, a PDA, a smartwatch, a dedicated mobile device, a desktop computer, a laptop computer, or other internet accessible device, machine, or hardware. The user device 110 may be used to transmit, initiate, create, send, etc. (e.g. over a network) a customer support ticket to computing system 120, for handling by a customer support team. Embodiments of the user device 110 may connect to the computing system 120 over network 107. The user device 110 may be running one or more software applications associated with the social networking platform 111, as well as a customer support ticketing application.

Referring still to FIG. 1, embodiments of the prioritization system 100 may include a social network platform 111. Embodiments of the social network platform 111 may be communicatively coupled to the computing system 120 over computer network 107. Embodiments of the social network platform 111 of the prioritization system 100 depicted in FIG. 1 may be one or more social media platforms, team collaborative platforms, social networking websites, document collaboration and sharing platforms, and the like. Moreover, embodiments of social network platform 111 may be one or more websites, applications, databases, storage devices, repositories, servers, computers, engines, and the like, that may service, run, store or otherwise contain information and/or data regarding a social network of the user and the user's social contacts across the platforms. The social network platform or platforms 111 may be accessed or may share a communication link over network 107, and may be managed and/or controlled by a third party. In an exemplary embodiment, the social network platform 111 may be a social media network, social media website, social media engine, and the like, which may store or otherwise contain content supplied by a social contact of the user, as well as content shared by a user on the social network platform 111.

Furthermore, embodiments of the computing system 120 may be equipped with a memory device 142 which may store various data/information/code, and a processor 141 for implementing the tasks associated with the prioritization system 100. In some embodiments, a prioritization application 130 may be loaded in the memory device 142 of the computing system 120. The computing system 120 may further include an operating system, which can be a computer program for controlling an operation of the computing system 120, wherein applications loaded onto the computing system 120 may run on top of the operating system to provide various functions. Furthermore, embodiments of computing system 120 may include the prioritization application 130. Embodiments of the prioritization application 130 may be an interface, an application, a program, a module, or a combination of modules. In an exemplary embodiment, the prioritization application 130 may be a software application running on one or more back end servers, servicing a customer support ticket system of a customer support management team/division.

The prioritization application 130 of the computing system 120 may include a receiving module 131, a calculating module 132, a weighting module 133, and a prioritization module 134. A “module” may refer to a hardware-based module, software-based module or a module may be a combination of hardware and software. Embodiments of hardware-based modules may include self-contained components such as chipsets, specialized circuitry and one or more memory devices, while a software-based module may be part of a program code or linked to the program code containing specific programmed instructions, which may be loaded in the memory device of the computing system 120. A module (whether hardware, software, or a combination thereof) may be designed to implement or execute one or more particular functions or routines.

Embodiments of the receiving module 131 may include one or more components of hardware and/or software program code for receiving a customer support ticket from a user. For instance, embodiments of the receiving module 131 may receive a customer support ticket initiated and transmitted from the user device 110. In an exemplary embodiment, the receiving module 131 may receive and/or process the customer support ticket or a request to create/generate a customer support ticket, for analysis by the prioritization application 130. Furthermore, embodiments of the receiving module 131 may assign a default severity level to the customer support ticket. The default severity level may be categorized in a series of levels, such as severity level 4, severity level 3, severity level 2, and severity level 1. Many different categorization schemes may be used to assign a default severity level of the customer support ticket. The default severity level determination by the receiving module 131 may be based on conventional methods of severity determination, including arbitrary assignment techniques, customer/user suggested severity levels, and other known methods.

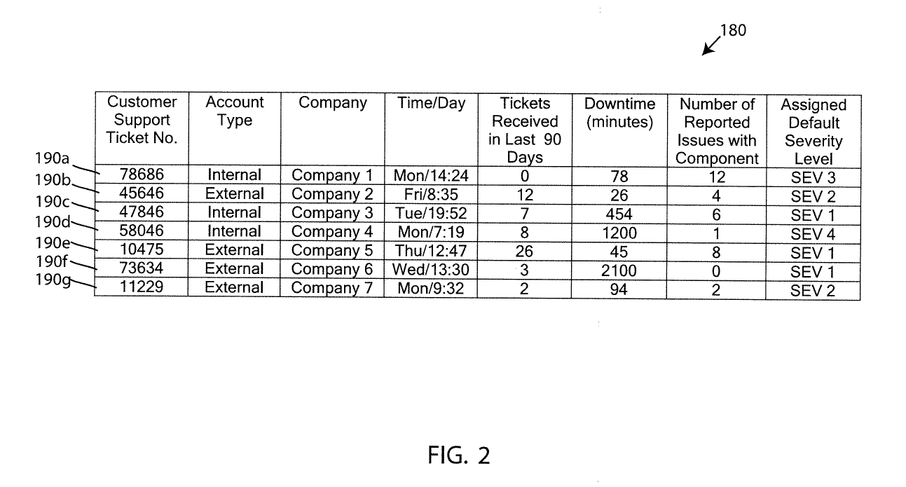

Embodiments of the receiving module 131 may also create a customer support ticket queue. FIG. 2 depicts a queue 180 of a plurality of customer support tickets, in accordance with embodiments of the present invention. The queue 180 includes customer support ticket 190a, customer support ticket 190b, customer support ticket 190c, customer support ticket 190d, customer support ticket 190e, customer support ticket 190f, and customer support ticket 190g. Each of the customer support tickets 190a, 190b, 190c, 190d, 190e, 190f, 190g contains information for analysis by the computing system operating prioritization application 130. Further, customer support tickets 190a, 190b, 190c, 190d, 190e, 190f, 190g have each been assigned a default severity level (e.g. SEV4-SEV1).

Referring again to FIG. 1, embodiments of the computing system 120 may further include a calculating module 132. Embodiments of the calculating module 132 may include one or more components of hardware and/or software program for calculating a user sentiment score and a user personality score by applying a sentiment analysis and a personality analysis to user-specific data. Embodiments of user-specific data may be a user activity and/or a user shared content across one or more social network platforms, a voice data of the user, a content of the customer support ticket, a customer relationship management (CRM) data, and combinations thereof. Embodiments of the calculating module 132 may identify an identity of the user submitting the customer support ticket, in response to receiving the customer support ticket from the user. For instance, embodiments of the content calculating module 132 may, in response to receiving the customer support ticket from the user, analyze the customer support ticket to determine a user identity and other data points from the content of the customer support ticket. The content of the customer support ticket may be analyzed by a text analysis system that may parse, identify, scan, detect, analyze etc. words using, for example, a natural language processing technique, natural language classification, pre-trained language model, etc. to analyze the content of the customer support ticket. The content of the customer support ticket may be a user identity, a recency of the customer support ticket, a frequency of reported support tickets, a type of account, a number of times the user has issued a support ticket for a same issue, a component involved in the customer support ticket, a time of day, a day of a week, an amount of downtime, and account specific information, and the like. The calculating module 132 may also access the CRM database 113 for additional user identification information.

Embodiments of the calculating module 132 may thus process the customer support ticket so that the computing system 120 can obtain and analyze user-specific data pertaining to the user activity and/or the user shared content on one or more social network platforms 111. The user activity and the user shared content that may be analyzed for sentiment, an emotional status of the user, and/or personality insights may relate to a topic associated with the customer support ticket. Embodiments of the calculating module 132 may include one or more components of hardware and/or software program for analyzing a social network activity of the user to determine that the social media activity of the user on one or more social media platforms 111 relates or is relevant to the customer support ticket. For instance, in response to receiving a customer support ticket and determining the content of the customer support ticket, including a user information, the calculating module 132 may analyze, parse, scan, review, etc. a user's shared content and the user's activity on a user's social network account(s), as well as a shared content and an activity of the user on social contacts of the user, shared or otherwise available or accessible on one or more social network platforms 111. The analyzing may be performed to determine that a content shared by the user across the social network platform 111 is relevant or otherwise correlates to the content of the customer support ticket. In an exemplary embodiment, calculating module 132 may analyze a user's social network activity via content shared by the user on the user's social network page as well as on social contacts' social network page. The calculating module 132 may ascertain a context of the shared content, and then determine whether the context of the shared content correlates or is relevant to the content of the customer support ticket received from the user device 110 of the user. The shared content shared, uploaded, or otherwise posted on the social network platform 111 may be photographs, videos, comments made on other contacts' pages, text-based posts made to the social contact's own social network page, and the like. The shared content may be analyzed, parsed, scanned, searched, inspected, etc. for a context that correlates or otherwise relates to or is associated with the customer support ticket including a company responsible for satisfying the user and handling the customer support ticket. In an exemplary embodiment, the calculating module 132 may utilize a natural language technique to determine keywords associated with the content available on the social network platform 111, and then examine the determined keywords with keywords that may be relatable with content encompassed by customer support ticket. In another exemplary embodiment, the calculating module 132 may utilize an image or visual recognition engine to inspect, parse, scan, analyze, etc. a photograph, image, video, or other content to determine one or more descriptions or insights that describe or are associated with the photograph, image, video, or other content, and then examine the descriptions/insights with keywords that may be relatable with the content encompassed by the customer support ticket. In yet another embodiment, the calculating module 132 may use a combination of natural language techniques, cognitive applications/engines, and visual recognition engines to determine a context, content, and relevancy of the shared content available on the one or more social network platforms for comparison with the content of the customer support ticket.

Moreover, embodiments of the calculating module 132 may compare the determined context and content from the shared content with the content of the customer support ticket received by the receiving module 131. For instance, keywords, texts, insights, or other acquired computer readable information associated with the analyzed shared social network content and user social network activity may be compared with keywords, texts, insights, or other computer readable information associated with the content of the customer support ticket. Based on the comparison, the calculating module 132 may determine that the content of a particular social network content supplied by the user on the user's social network may be relevant or otherwise correlate to the content of the received customer support ticket.

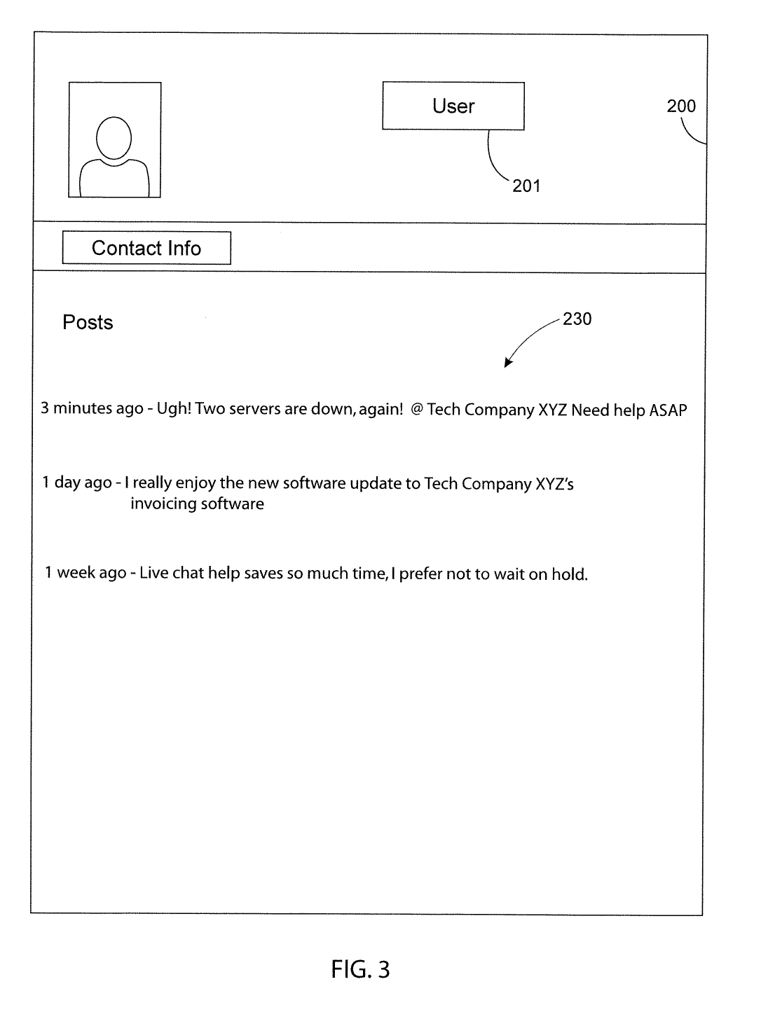

Turning now to FIG. 3 for an example of analyzing a social network activity of the user (e.g. posts, shared content, frequency of logins, etc.) on one or more social network platforms 111 to determine that the content of the social network activity of the user on one or more social network platforms 111 is relevant to the customer support ticket. FIG. 3 depicts a social network page 200 of a user 201, containing shared content 230, in accordance with embodiments of the present invention. The social media page 200 may include a name or identity 201 of the user and contact information. The calculating module 132 may analyze the social network page 200 to determine whether the user's social network page 200 contains any content or activity that may be relevant to the customer support ticket. Here, the shared content on the user's social network page 200 includes content 230. Embodiments of the calculating module 132 may analyze comments 230 posted by user on the user's social network page 200. In the comments, the user has posted text relating to “servers,” “Tech Company XYZ,” “help,” “software,” and “update,” These keywords may be associated with a context of a customer support ticket, for example, being received by Tech Company XYZ, which can correlate to or can be relevant to an exemplary customer support ticket relating to computer technology.

Furthermore, embodiments of the calculating module 132 may perform a sentiment analysis and/or a personality analysis to the content on the user's social media page 200 to determine a sentiment, emotional status, and/or intention, as well as gain insights into a personality of the user. Sentiment analysis may be performed by the calculating module 132 to help the computing system 120 understand and/or learn a sentiment and/or current emotional status associated with the customer support ticket, including a sentiment regarding a company handling the customer support ticket, a software, an update, a product, a service, a good, and the like. A sentiment may refer to whether the shared content, a feeling of the user, an attitude of the user, a context of the shared content, and/or mental state of the user is positive, negative, or neutral. The sentiment may be derived from natural language processing and sentiment analysis techniques, and may be evaluated or scored on a range or sentiment scale. An intention may refer to an act that a user may take, such as a buying a product, going to a movie, calling customer service, taking a trip, and the like.

Embodiments of the calculating module 132 may run a sentiment analysis (e.g. for all data sources) using emotion analysis classification models to retrieve a satisfaction data as an input to be used for calculating a user sentiment score. In an exemplary embodiment, the calculating module 132 may use a Naive Bayes classifier trained on customized emotion lexicon. In other embodiments, the calculating module 132 may use computationally intensive classifiers, such as boosted trees, random forests, support vector machines, etc. The sentiment score may include a determination of a user's emotional status (e.g. angry, frustrated, content, etc.). For example, the calculating module 132 may determine whether the user is angry, frustrated, calm, etc. when submitting a customer support ticket. The sentiment analysis may listen to users on social channels to learn a user's true emotion, and may also create an early warning system, such as setting up a threshold of anger emotions to help identify when a situation may be getting worse. The calculating module 132 may be used to monitor changes in sentiment and emotion as a reaction to introductions of new products, services, features, updates, and the like.

In the comments 230 of the social network page 200, the user has “tagged” Tech Company XYZ, and used the word “Ugh” when referring to “servers” being “down,” “again.” The calculating module 132 may conclude that the user is currently angry and frustrated, and has a negative feeling about Tech Company XYZ at the moment, and thus may affect a severity of the customer support ticket received from the user 201. However, the user 201 one day ago used the words “really enjoy” when referring to Tech Company XYZ and “new software update” and “invoicing software.” The calculating module 132 may conclude that the user is happy and has a positive feeling about a new software update to an invoicing software supported by Tech Company XYZ about one day prior to submitting the customer support ticket, and thus may also affect a severity of the customer support ticket received from the user 201.

Moreover, embodiments of the calculating module 132 may track occurrences of positive and negative sentiment and assign a point value to each occurrence (e.g. +2 points for negative sentiment occurrence, −1 point for positive sentiment occurrence). Various techniques may be employed to assigning a score or points to a sentiment occurrence. In an exemplary embodiment, the calculating module 132 may determine a degree of sentiment, such as positive, very positive, negative, very negative, etc., which may result in more points being assigned to a higher degree of positive/negative occurrences. By assigning a numeric value to each detected occurrence of sentiment relevant to the customer support ticket, the calculating module 132 may be able to calculate a user sentiment score (e.g. numeric value) based on the sentiment analysis of user activity/content on one or more social media platforms 111. The user sentiment score for user activity/content on one or more social media platforms 111 may be combined with a user sentiment score based on other data sources, such as the customer support ticket, voice calls, and CRM database 113.

Similarly, in the comments 230, the user has very recently used the word “ASAP” when referring to needing help. The calculating module 132 may thus conclude that the user may be impatient or may be demanding in times of need. Further, the comments 230 include a previous statement, “I prefer not to wait on hold.” Based on this statement, the calculating module 132 may further conclude that the user is impatient, or less patient than other users, which may affect a severity of the customer support ticket. Moreover, embodiments of the calculating module 132 may track occurrences of personality insights gained and assign a point value to each occurrence (e.g. +2 points for insight into a lower patience trait/attribute, −1 point for insight into a higher patience trait/attribute). Various techniques may be employed to assigning a score or points to a personality insight occurrence. In an exemplary embodiment, the calculating module 132 may determine a degree of insight into personality of the user, which may result in more points being assigned to a higher degree of reliability of the personality insight. By assigning a numeric value to each detected occurrence of personality insight of the user, the calculating module 132 may be able to calculate a user personality score (e.g. numeric value) based on the personality analysis of user activity/content on one or more social media platforms 111. The user personality score for user activity/content on one or more social media platforms 111 may be combined with a user personality score based on other data sources, such as the customer support ticket, voice calls, and CRM database 113.

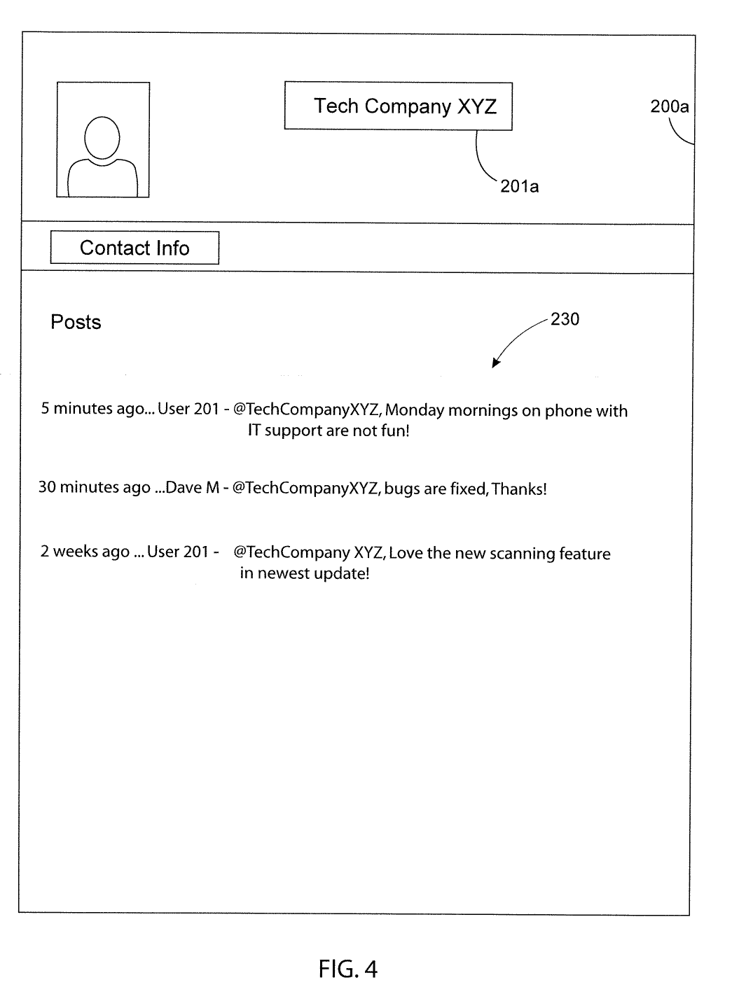

Turning now to FIG. 4 for another example of analyzing a social network activity of the user (e.g. posts, shared content, frequency of logins, etc.) on one or more social network platforms 111 to evaluate a sentiment and/or a personality of the user. FIG. 4 depicts a social network page 200a of an entity 201a, containing shared content 230, in accordance with embodiments of the present invention. The social media page 200a may include a name or identity 201a of the entity (e.g. Tech Company XYZ). The calculating module 132 may analyze the social network page 200a because the entity is managing the customer support ticket. Embodiments of the calculating module 132 may perform a sentiment analysis and/or a personality analysis to the content on social network page 200a to determine a sentiment and/or intention, as well as gain insights into a personality of the user. Sentiment analysis may be performed by the calculating module 132 to help the computing system 120 understand and/or learn a sentiment associated with the entity and/or the customer support ticket. In the comments 230, the user has used the words “not fun” when referring to being on the phone with the IT support department of the entity 201a handling the customer support ticket. The calculating module 132 may conclude that the user has a negative feeling about Tech Company XYZ at the moment, and thus may affect a severity of the customer support ticket received from the user 201. However, the user 201 two weeks ago used the words “love” when referring to Tech Company XYZ and “new scanning feature” and “newest update.” The calculating module 132 may conclude that the user has a positive feeling about a new software update and feature provided by Tech Company XYZ about two weeks prior to submitting the customer support ticket, and thus may also affect a severity of the customer support ticket received from the user 201. Moreover, embodiments of the calculating module 132 may track occurrences of positive and negative sentiment and assign a point value to each occurrence (e.g. +2 points for negative sentiment occurrence, −1 point for positive sentiment occurrence). Various techniques may be employed to assigning a score or points to a sentiment occurrence. In an exemplary embodiment, the calculating module 132 may determine a degree of sentiment, such as positive, very positive, negative, very negative, etc., which may result in more points being assigned to a higher degree of positive/negative occurrences. By assigning a numeric value to each detected occurrence of sentiment relevant to the customer support ticket on the social network page 201a of an entity, the calculating module 132 may be able to calculate a user sentiment score (e.g. numeric value) based on the sentiment analysis of user activity/content on one or more social media platforms 111. The user sentiment score for user activity/content on one or more social media platforms 111 may be combined with a user sentiment score based on other data sources, such as the customer support ticket, voice calls, and CRM database 113.

Moreover, embodiments of the calculating module 132 may analyze a recent history of shared social network content and activity of the user for a specified data range measured from receiving the customer support ticket. For instance, the calculating module 132 may analyze the social network activity of the user for a period of time, measured backwards from the time of the receiving the customer support ticket, such as an hour, a day, a week, a couple of weeks, a month, a couple of months, a year, and the like. By analyzing a recent social network activity of the user, the computing system 120 may follow or track changes in the user's feelings about the entity or entity's products/services over time. Further, social network activity may include recent text posts, recent check-ins, recent photo uploads, recent “liked” items, and recent re-shares.

Referring back to FIG. 1, embodiments of the calculating module 132 may analyze user-specific data pertaining to voice data of the user. Embodiments of the voice data may be user voice data associated with at least one of: one or more previous support calls, a current support call, and a combination of the one or more previous support calls and the current call. For instance, the voice data may be audio of the user obtained during a support call between the user and a customer support department representative, wherein the calls may be recorded and stored in one or more databases, such as a support call database 112. Embodiments of the support call database 112 may be one or more databases, storage devices, repositories, and the like, that may store or otherwise contain information and/or data regarding voice data, including audio recordings and/or text of the audio calls, of the user in one or more interactions with a call support team, department, representative and the like. The support call database 112 may also be accessed over network 107, and may be affiliated with, managed, and/or controlled by one or more third parties, such as a customer support division of a company. The voice data may be processed by a speech-to-text application for data processing, for example, using natural language techniques. The voice data may be analyzed for sentiment that may relate to a topic associated with the customer support ticket and/or may be analyzed to gain insights on a personality of the user. For instance, in response to receiving a customer support ticket, the calculating module 132 may analyze, parse, scan, review, etc. voice data of the user to calculate a sentiment score associated with the voice data and a personality score associated with the voice data. In an exemplary embodiment, the calculating module 132 may access the support call database 112 to analyze the voice data of the user, which may be voice data from previous calls. In another embodiment, the calculating module 132 may access the support call database 112 to obtain a previously calculated sentiment score and/or personality score associated with the voice data, and may perform the sentiment analysis and/or personality analysis real-time during a current call, and modify the scores accordingly.

Voice data of the user may be used to gain personality insights of the user based on historical and/or current interaction of the user and a representative(s) of the customer support team. For example, the calculating module 132 may determine that a user has a high patience level based on a calm demeanor during a long support call. If during a support call a user made demands with a tone of voice that indicates that the user is angry, the calculating module 132 (e.g. using WATSON PI) may determine that the user is demanding. Embodiments of the calculating module 132 may also detect a level of anger based on the voice data of the user. For instance, the user voice data may indicate that the user has a demanding personality trait, but may also detect that the tone of the user's voice denotes an angry emotional status. Various personality traits may be determined by the personality analysis of the voice data, which may be used to calculate a personality score. Moreover, embodiments of the calculating module 132 may track occurrences of personality insights gained and assign a point value to each occurrence (e.g. +2 points for insight into a lower patience trait/attribute, −1 point for insight into a higher patience trait/attribute). Various techniques may be employed to assigning a score or points to a personality insight occurrence. In an exemplary embodiment, the calculating module 132 may determine a degree of insight into personality of the user, which may result in more points being assigned to a higher degree of reliability of the personality insight. By assigning a numeric value to each detected occurrence of personality insight of the user, the calculating module 132 may be able to calculate a user personality score (e.g. numeric value) based on the personality analysis of voice data of the user. The user personality score for voice data may be combined with a user personality score based on other data sources, such as the customer support ticket, social network activity, and CRM database 113.

With continued reference to FIG. 1, embodiments of the calculating module 132 may analyze user-specific data pertaining to customer relationship (CRM) data. Embodiments of the CRM data may include a customer lifetime value (CLV), a contact information of the user, an organization associated with the user, an experience level of the user, and a total number of accounts associated with the user. For instance, the CRM data may be stored in one or more databases, such as a CRM database 113. Embodiments of the CRM database 113 may be one or more databases, storage devices, repositories, and the like, that may store or otherwise contain information and/or data regarding CRM data. The CRM database 113 may also be accessed over network 107, and may be affiliated with, managed, and/or controlled by a customer support division of a company. The CRM data may be analyzed for sentiment that may relate to a topic associated with the customer support ticket and/or may be analyzed to gain insights on a personality of the user. For instance, in response to receiving a customer support ticket, the calculating module 132 may analyze, parse, scan, review, etc. CRM data of the user to calculate a sentiment score associated with the CRM data and a personality score associated with the CRM data. In an exemplary embodiment, the calculating module 132 may access the CRM database 113 to analyze the CRM data associated with the user. In another embodiment, the calculating module 132 may access the CRM database 113 to obtain a previously calculated sentiment score and/or personality score associated with the CRM data. The user personality score and sentiment score, if any, from the CRM data may be combined with a user personality score and user sentiment score based on other data sources, such as the customer support ticket, social network activity, and voice data from the support call database 112.

Embodiments of the calculating module 132 may analyze user-specific data pertaining to the customer support ticket. Embodiments of the customer support ticket data may include a recency of the customer support ticket, a frequency of reported support tickets, a type of account, a number of times the user has issued a support ticket for a same issue, a component involved in the customer support ticket, a time of day, a day of a week, an amount of downtime, and account specific information. The customer support ticket data may be analyzed for sentiment that may relate to a topic/issue associated with the customer support ticket and/or may be analyzed to gain insights on a personality of the user. For instance, in response to receiving a customer support ticket, the calculating module 132 may analyze, parse, scan, review, etc. customer support ticket data of the user to calculate a sentiment score associated with the customer support ticket data and a personality score associated with the customer support ticket data. A personality analysis of the customer support ticket may determine a patience level of the user, a technical skill level of the user, and a communication style of the user, based on the text of the customer support ticket. The user personality score and sentiment score, if any, from the customer support ticket data may be combined with a user personality score and user sentiment score based on other data sources, such as the CRM data, social network activity, and voice data from the support call database 112.

Accordingly, embodiments of the calculating module 132 may calculate a user sentiment score and a user personality score from a plurality of data sources, including social network activity of the user, CRM data, customer support ticket data, and voice data of the user. The calculating module 132 may aggregate the points assigned to occurrences detected and calculate a total score (e.g. numerical value) for the user sentiment score and the user personality score, respectively. In some embodiments, the user sentiment score and the user personality score may be combined to define a single user-specific score for application of the weighting scheme.

Referring back to FIG. 1, embodiments of the computing system 120 may also include a weighting module 133. Embodiments of the weighting module 133 may include one or more components of hardware and/or software program code for applying a weighting scheme to the user sentiment score and the user personality score to generate a weighted priority score associated with the customer support ticket. For instance, embodiments of the weighting module 133 may use one or more data science prediction algorithms to analyze a plurality of sentiment inputs (e.g. occurrence of sentiment from data source) resulting from the sentiment analysis and a plurality of personality inputs (e.g. occurrence of personality insight) resulting from the personality analysis to determine a weight of the weighting scheme to be applied to the user sentiment score and the user personality score. In an exemplary embodiment, the weight to be applied to the user sentiment score and the user personality score may be based on an impact on a severity of the customer support ticket. For example, an occurrence of the user being very angry may result in a more significant impact on the severity of the customer support ticket than an occurrence of a sentiment that the user appreciates the newest software update. The weighting module 133 may aggregate the results of the data science prediction algorithm to determine a weight to be applied to the user sentiment score and the user personality score.

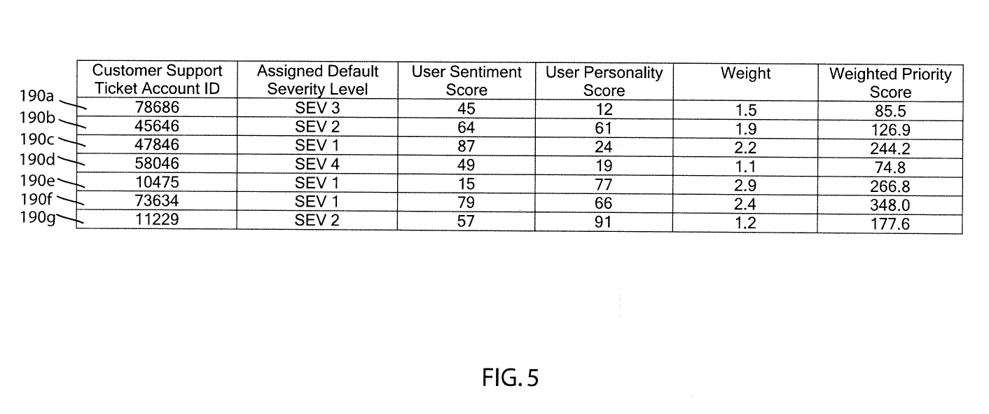

FIG. 5 depicts a table showing a weighted priority score calculated for a plurality of customer support tickets 190a, 190b, 190c, 190d, 190e, 190f, 190g, in accordance with embodiments of the present invention. Here, the user sentiment score and the user personality score is depicted, as well as the weight to be applied to the user sentiment score and the user personality score. In an exemplary embodiment, the user sentiment score may be added to the personality score, and then the weight may be multiplied to the sum of the user sentiment score and the user personality score to arrive at a weighted priority score for each of the plurality of customer support tickets 190a, 190b, 190c, 190d, 190e, 190f, 190g.

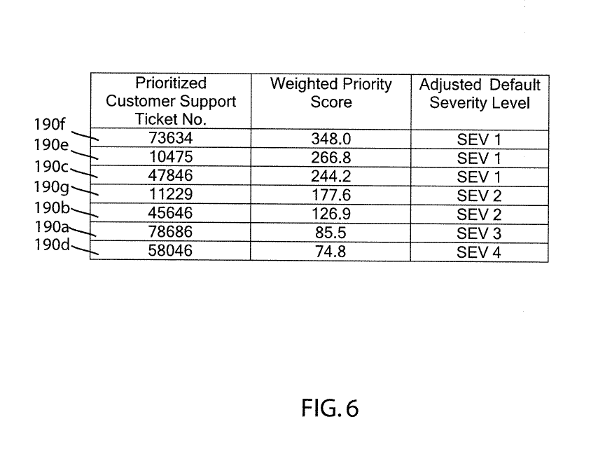

Referring back to FIG. 1, embodiments of the computing system 120 may also include a prioritization module 134. Embodiments of the prioritization module 134 may include one or more components of hardware and/or software program code for adjusting the default severity level according to the weighted priority score to determine an adjusted severity level of the customer support ticket, and prioritizing the customer support ticket among other customer support tickets based on the adjusted severity level of the customer support ticket. FIG. 6 depicts a table showing an adjusted priority for the plurality of customer support tickets 190a, 190b, 190c, 190d, 190e, 190f, 190g. The default severity level may be adjusted in view of the weighted priority score. In an exemplary embodiment, the levels of severity may be categorized by a weighted priority score being within a particular range of a plurality of ranges of various weighted priority scores (e.g. level 4 being between 0-75). Further, embodiments of the prioritization module 134 may prioritize the customer support tickets having the same severity level based on the weighted priority score. As shown in FIG. 6, customer support tickets 190f, 190e, 190c each have an adjusted severity level of SEV 1. However, embodiments of the prioritization module 134 may now be able to reorder the customer support tickets and establish a more accurate severity level between customer support tickets having a same severity level using the weighted priority score.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic-based circuitry) (independently or in combination) particularized for executing only methods of the present invention. The specialized discrete non-generic analog, digital, and logic-based circuitry may include proprietary specially designed components (e.g., a specialized integrated circuit, such as for example an Application Specific Integrated Circuit (ASIC), designed for only implementing methods of the present invention). Moreover, embodiments of the prioritization system 100 offers a method to prioritize customer support tickets using a cognitive approach to determine user sentiment and user personality from a plurality of data sources. The prioritization system 100 may be individualized to each customer support ticket, by analyzing the user sentiment and personality.

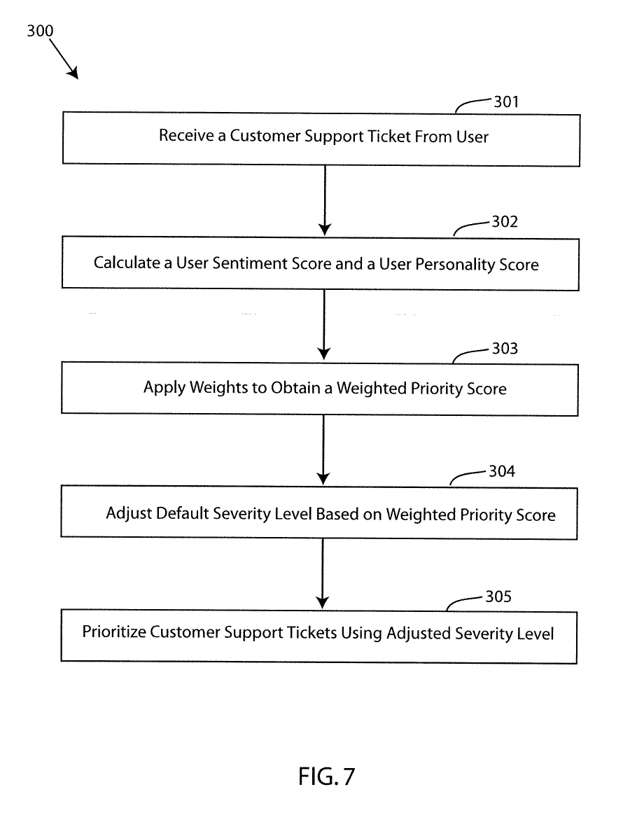

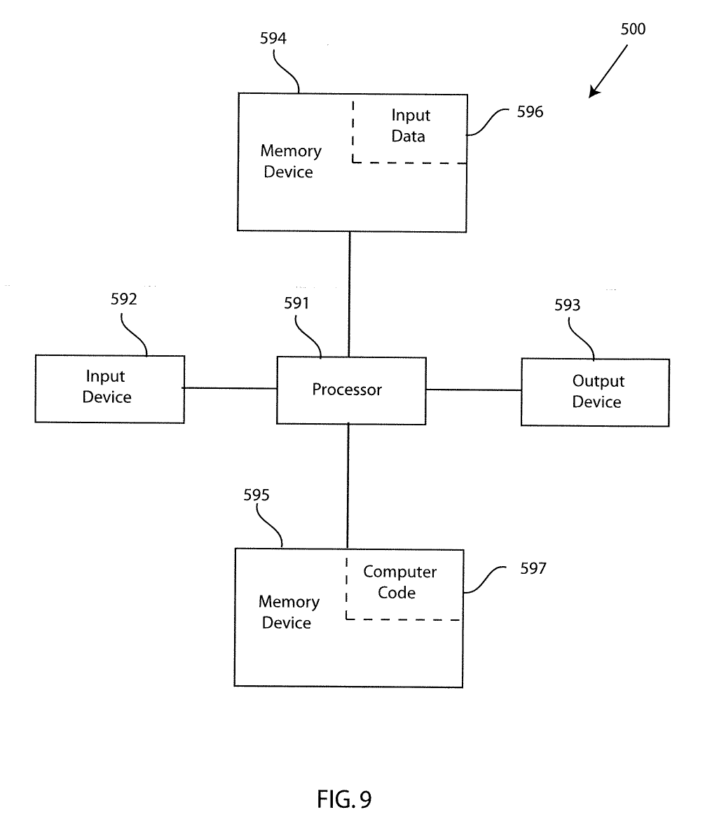

Referring now to FIG. 7, which depicts a flow chart of a method 300 for prioritizing a customer support ticket system, in accordance with embodiments of the present invention. One embodiment of a method 300 or algorithm that may be implemented for prioritizing a customer support ticket system with the prioritization system 100 described in FIGS. 1-6 using one or more computer systems as defined generically in FIG. 9 below, and more specifically by the specific embodiments of FIG. 1.

Embodiments of the method 300 for prioritizing a customer support ticket system, in accordance with embodiments of the present invention, may begin at step 301 wherein a customer support ticket is received from a user via user device 110. Step 302 calculates a user sentiment score and a user personality score. Step 303 applies weights to the user sentiment score and the user personality score to obtain a weighted priority score. Step 304 adjusts the default severity level based on the weighted priority score. Step 305 prioritizes the customer support ticket using the adjusted severity level.

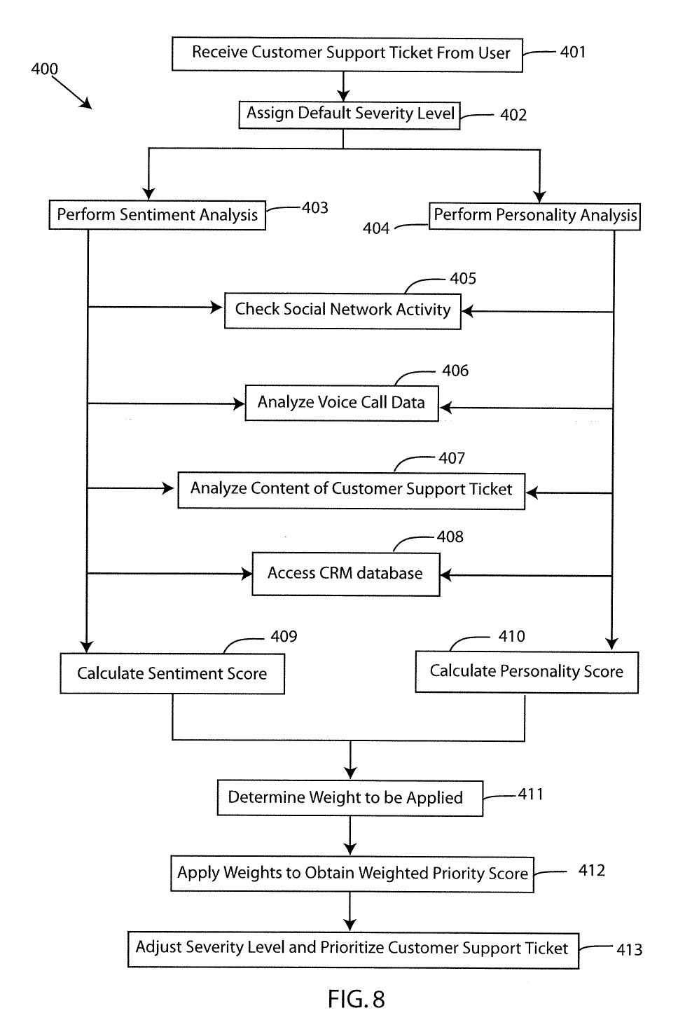

FIG. 8 depicts a detailed flow chart of a method 400 for prioritizing a customer support ticket system, in accordance with embodiments of the present invention. Embodiments of the method 400 for prioritizing a customer support ticket system may begin at step 401, wherein a customer support ticket is received. Step 402 assigns a default severity level to the customer support ticket. Step 403 initiates a sentiment analysis, and step 404 initiates a personality analysis, wherein steps 403 and 404 may be performed simultaneously. Step 405 checks a social network activity to obtain sentiment, emotional status, and/or personality insights. Step 406 analyzes voice data to obtain sentiment, emotional status, and/or personality insights. Step 407 analyzes a content of the customer support ticket to obtain sentiment, emotional status, and/or personality insights. Step 408 accesses a CRM database 113 to obtain sentiment, emotional status, and/or personality insights. Step 409 calculates a user sentiment score using results from steps 405-408. Step 410 calculates a user personality score using results from steps 405-408. Step 411 determines a weight to be applied to the user sentiment score and the user personality score. Step 412 applies the weights to the user sentiment score and the user personality score for each customer support ticket received in a customer support ticket queue 180. Step 413 adjusts the severity level of the customer support tickets and prioritizes the customer support ticket.

FIG. 9 depicts a block diagram of a computer system for the prioritization system 100 of FIGS. 1-6, capable of implementing methods for prioritizing a customer support ticket system of FIGS. 7-8, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer system 500, including executing instructions included in the computer code 597 for the tools and programs capable of implementing a method for prioritizing a customer support ticket system in the manner prescribed by the embodiments of FIGS. 7-8 using the prioritization system 100 of FIGS. 1-6, wherein the instructions of the computer code 597 may be executed by processor 591 via memory device 595. The computer code 597 may include software or program instructions that may implement one or more algorithms for implementing the method for prioritizing a customer support ticket system, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 9.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to prioritization systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer system 500) including one or more processor(s) 591, wherein the processor(s) carry out instructions contained in the computer code 597 causing the computer system to prioritize a customer support ticket system. Another embodiment discloses a process for supporting computer infrastructure, where the process includes integrating computer-readable program code into a computer system 500 including a processor.

The step of integrating includes storing the program code in a computer-readable storage device of the computer system 500 through use of the processor. The program code, upon being executed by the processor, implements a method for prioritizing a customer support ticket system. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for prioritizing a customer support ticket system.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

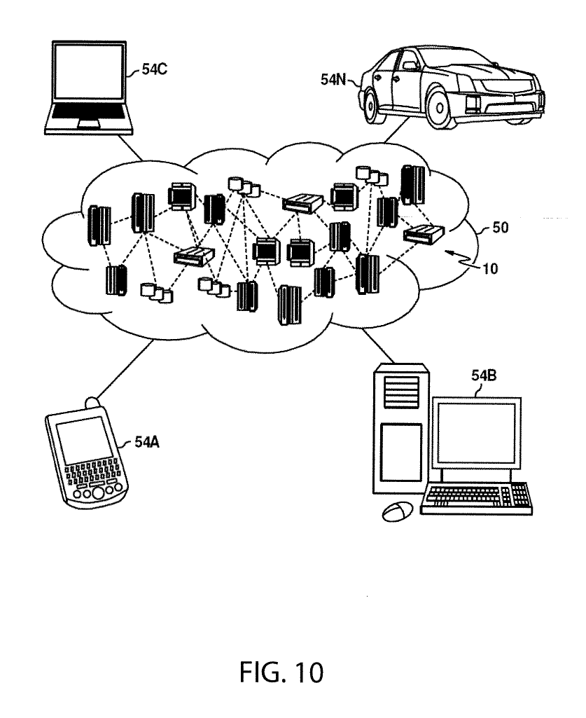

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 10 are intended to be illustrative only and that computing nodes 10 and cloud computing environment 50 can communicate with any type of computerized device over any type of network and/or network addressable connection (e.g., using a web browser).

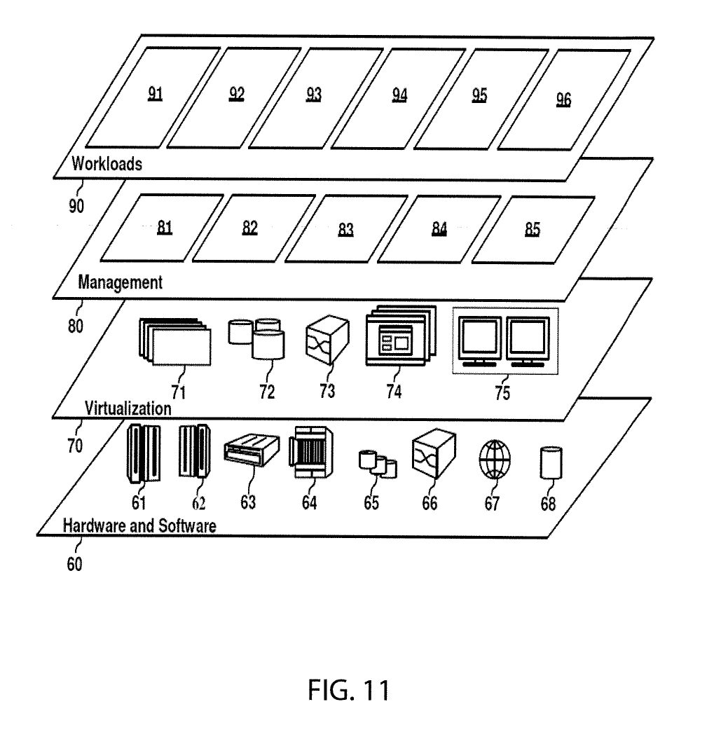

Referring now to FIG. 11, a set of functional abstraction layers provided by cloud computing environment 50 (see FIG. 10) are shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and alert modification 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for prioritizing a customer support ticket system, the method comprising:
receiving, by a processor of a computing system, a customer support ticket from a user, wherein a default severity level associated with the customer support ticket is assigned;
calculating, by the processor, a user sentiment score and a user personality score by applying a sentiment analysis and a personality analysis to user-specific data;
applying, by the processor, a weighting scheme to the user sentiment score and the user personality score to generate a weighted priority score associated with the customer support ticket,
adjusting, by the processor, the default severity level to an adjusted severity level according to the weighted priority score; and
prioritizing, by the processor, the customer support ticket among other customer support tickets based on the adjusted severity level of the customer support ticket.

2. The method of claim 1, wherein the user specific data is a member of the group consisting of: a user activity and a user shared content across one or more social network platforms, a voice data of the user, a content of the customer support ticket, and a customer relationship management (CRM) data.

3. The method of claim 2, wherein:
the user activity and the user shared content relates to a topic associated with the customer support ticket;
the voice data of the user is associated with at least one of: one or more previous support calls, a current support call, and a combination of the one or more previous support calls and the current call;
the CRM data includes a customer lifetime value (CLV), a contact information of the user, an organization associated with the user, an experience level of the user, and a total number of accounts associated with the user; and
the content of the customer support ticket includes a recency of the customer support ticket, a frequency of reported support tickets, a type of account, a number of times the user has issued a support ticket for a same issue, a component involved in the customer support ticket, a time of day, a day of a week, an amount of downtime, and account specific information.

4. The method of claim 3, wherein analyzing the user activity and shared content includes analyzing a history of shared content of the user for a specified data range measured from receiving the customer support ticket.

5. The method of claim 1, wherein the sentiment analysis determines a sentiment of the user toward a topic associated with the customer support ticket, and an emotional status of the user at a time of submitting the customer support ticket.

6. The method of claim 1, wherein the personality analysis determines a personality of the user, including a patience level of the user, a technical skill level of the user, and a communication style of the user.

7. The method of claim 1, wherein one or more data science prediction algorithms are used to analyze a plurality of sentiment inputs resulting from the sentiment analysis and a plurality of personality inputs resulting from the personality analysis to determine a weight of the weighting scheme to be applied to the user sentiment score and the user personality score, further wherein the weight is based on an impact on a severity of the customer support ticket.

8. A computer system, comprising:
a processor;
a memory device coupled to the processor; and
a computer readable storage device coupled to the processor, wherein the storage device contains program code executable by the processor via the memory device to implement a method for prioritizing a customer support ticket system, the method comprising:
receiving, by a processor of a computing system, a customer support ticket from a user, wherein a default severity level associated with the customer support ticket is assigned;
calculating, by the processor, a user sentiment score and a user personality score by applying a sentiment analysis and a personality analysis to user-specific data;
applying, by the processor, a weighting scheme to the user sentiment score and the user personality score to generate a weighted priority score associated with the customer support ticket;
adjusting, by the processor, the default severity level to an adjusted severity level according to the weighted priority score; and
prioritizing, by the processor, the customer support ticket among other customer support tickets based on the adjusted severity level of the customer support ticket.

9. The computer system of claim 8, wherein the user specific data is a member of the group consisting of: a user activity and a user shared content across one or more social network platforms, a voice data of the user, a content of the customer support ticket, and a customer relationship management (CRM) data.

10. The computer system of claim 9, wherein:
the user activity and the user shared content relates to a topic associated with the customer support ticket;
the voice data of the user is associated with at least one of: one or more previous support calls, a current support call, and a combination of the one or more previous support calls and the current call;
the CRM data includes a customer lifetime value (CLV), a contact information of the user, an organization associated with the user, an experience level of the user, and a total number of accounts associated with the user; and
the content of the customer support ticket includes a recency of the customer support ticket, a frequency of reported support tickets, a type of account, a number of times the user has issued a support ticket for a same issue, a component involved in the customer support ticket, a time of day, a day of a week, an amount of downtime, and account specific information.

11. The computer system of claim 10, wherein analyzing the user activity and shared content includes analyzing a history of shared content of the user for a specified data range measured from receiving the customer support ticket.

12. The computer system of claim 8, wherein the sentiment analysis determines a sentiment of the user toward a topic associated with the customer support ticket, and an emotional status of the user at a time of submitting the customer support ticket.

13. The computer system of claim 8, wherein the personality analysis determines a personality of the user, including a patience level of the user, a technical skill level of the user, and a communication style of the user.

14. The computer system of claim 8, wherein one or more data science prediction algorithms are used to analyze a plurality of sentiment inputs resulting from the sentiment analysis and a plurality of personality inputs resulting from the personality analysis to determine a weight of the weighting scheme to be applied to the user sentiment score and the user personality score, further wherein the weight is based on an impact on a severity of the customer support ticket.

15. A computer program product, comprising a computer readable hardware storage device storing a computer readable program code, the computer readable program code comprising an algorithm that when executed by a computer processor of a computing system implements a method for prioritizing a customer support ticket system, the method comprising:
receiving, by a processor of a computing system, a customer support ticket from a user, wherein a default severity level associated with the customer support ticket is assigned;
calculating, by the processor, a user sentiment score and a user personality score by applying a sentiment analysis and a personality analysis to user-specific data;
applying, by the processor, a weighting scheme to the user sentiment score and the user personality score to generate a weighted priority score associated with the customer support ticket;
adjusting, by the processor, the default severity level to an adjusted severity level according to the weighted priority score; and
prioritizing, by the processor, the customer support ticket among other customer support tickets based on the adjusted severity level of the customer support ticket.

16. The computer program product of claim 15, wherein the user specific data is a member of the group consisting of: a user activity and a user shared content across one or more social network platforms, a voice data of the user, a content of the customer support ticket, and a customer relationship management (CRM) data.

17. The computer program product of claim 16, wherein:
the user activity and the user shared content relates to a topic associated with the customer support ticket;
the voice data of the user is associated with at least one of: one or more previous support calls, a current support call, and a combination of the one or more previous support calls and the current call;
the CRM data includes a customer lifetime value (CLV), a contact information of the user, an organization associated with the user, an experience level of the user, and a total number of accounts associated with the user; and
the content of the customer support ticket includes a recency of the customer support ticket, a frequency of reported support tickets, a type of account, a number of times the user has issued a support ticket for a same issue, a component involved in the customer support ticket, a time of day, a day of a week, an amount of downtime, and account specific information.

18. The computer program product of claim 17, wherein analyzing the user activity and shared content includes analyzing a history of shared content of the user for a specified data range measured from receiving the customer support ticket.

19. The computer program product of claim 15, wherein the sentiment analysis determines a sentiment of the user toward a topic associated with the customer support ticket, and an emotional status of the user at a time of submitting the customer support ticket.

20. The computer program product of claim 15, wherein one or more data science prediction algorithms are used to analyze a plurality of sentiment inputs resulting from the sentiment analysis and a plurality of personality inputs resulting from the personality analysis to determine a weight of the weighting scheme to be applied to the user sentiment score and the user personality score, further wherein the weight is based on an impact on a severity of the customer support ticket.
